(19) United States
(12) Patent Application Publication
(10) Pub. No.: US 2004/0251292 A1
(43) Pub. Date: Dec. 16, 2004

(54) Package containing two different substrates

(76) Inventors: Loic Henri Raymond Grebonval, Flocques (FR); Scott Allen Baum, Hortonville, WI (US)

Correspondence Address: KIMBERLY-CLARK WORLDWIDE, INC., 401 NORTH LAKE STREET, NEENAH, WI, 54956

(21) Appl. No.: 10/461,605

(22) Filed: Jun. 13, 2003

(51) Int. Cl. B26F 3/02

(52) U.S. Cl. 225/39; 206/409

(57) ABSTRACT

A co-packaged product for co-packaging two different substrates is disclosed. The co-packaged product comprises a first substrate wound into a roll having an interior space housed within an enclosure. A second substrate is located within a container. The container can be placed into a container opening in the enclosure such that at least a portion of the container resides within the interior space of the roll. In one embodiment, a roll of shop towels is housed within a cardboard enclosure and a wet wipes container is placed through a container opening in the enclosure such that at least a portion of the container is positioned within the core of the roll.

### BACKGROUND

Often substrates are packaged as a roll of individual sheets or as a stack of sheets, which can be folded within the stack if desired. While these packaging formats are useful, a consumer who desires utilizing two different substrates, such as a wet substrate and a dry substrate for cleaning or other purposes, must buy and store two individually packaged products. This often results in one or both of the packages being stored under a counter or in a drawer since insufficient space can prevent both products from being placed in a readily accessible position. Because cleaning is a chore, people want it done as quickly as possible and they will reach for whatever is readily available. Therefore, if both substrates are not readily available, the stored substrate is often not utilized. Thus, a need exists for a convenient way of packaging and dispensing two different substrates.

### SUMMARY

The inventors have found that by placing another substrate within the previously wasted interior space of a roll, such as the interior space of a core, a convenient package for two different substrates results.

Thus, in one embodiment, the invention resides in a combination including a first substrate wound into a roll having an interior space, and the roll housed within an enclosure; a second substrate located within a container; and at least a portion of the container placed into the interior space.

In another embodiment, the invention resides in a combination including a first substrate wound into a roll about a core having an interior space, and the roll housed within an enclosure; the enclosure including a top, a bottom, a sidewall, a container opening, and a dispensing opening; a container including a cylindrical body having a diameter D, the container housing a second substrate; and the container placed within the container opening of the enclosure such that at least a portion of the container resides within the interior space of the core.

In another embodiment, the invention resides in a product including an enclosure having a container opening housing a first substrate wound into a roll and instructions directing the placement of a container housing a second substrate into the container opening.

In another embodiment, the invention resides in a product comprising a container housing a second substrate and instructions directing the placement of the container into a container opening in an enclosure housing a roll of a first substrate.

In another embodiment, the invention resides in a kit including an enclosure having a container opening housing a roll of a first substrate, and the roll having an interior space; a container housing a second substrate; and instructions for placing the container into the container opening such that at least a portion of the container resides within the interior space of the roll.

### BRIEF DESCRIPTION OF THE DRAWINGS

The above aspects and other features, aspects, and advantages of the present invention will become better understood with regard to the following description, appended claims, and accompanying drawings where:

FIG. 1 illustrates one embodiment of the invention.

FIG. 2 illustrates another embodiment of the invention.

FIG. 3 illustrates a cross-section of the embodiment of FIG. 2 prior to dispensing of the second substrate.

FIG. 4 illustrates one embodiment of the enclosure.

FIG. 5 illustrates another embodiment of the enclosure.

FIG. 6 illustrates another embodiment of the enclosure.

FIG. 7 illustrates a cross-section of one embodiment for the container.

FIG. 8 illustrates another embodiment for the container.

FIG. 9 illustrates another embodiment of the invention.

### DEFINITIONS

As used herein forms of the words of “comprise”, “have”, and “include” are legally equivalent and are open-ended. Therefore, additional non-recited elements, functions, steps, or limitations may be present in addition to the recited elements, functions, steps, or limitations.

As used herein “substrate” is a flexible sheet or web material, which is useful for household chores, personal care, health care, food wrapping, and cosmetic application or removal.

Non-limiting examples of suitable substrates of the present invention include nonwoven substrates, woven substrates, hydro-entangled substrates, air-entangled substrates, paper substrates comprising cellulose such as tissue, toilet paper, or paper towels, waxed paper substrates, coform substrates, wet wipes, film or plastic substrates such as those used to wrap food, and metal substrates such as aluminum foil. Furthermore, laminated or plied together substrates of two or more layers of any of the preceding substrates are suitable.

Further examples of suitable substrates include a substantially dry substrate (less than 10% by weight of water) containing lathering surfactants and conditioning agents either impregnated into or applied to the substrate such that wetting of the substrate with water prior to use yields a personal cleansing product. Such substrates are disclosed in U.S. Pat. No. 5,980,931 entitled Cleansings Products Having A Substantially Dry Substrate issued to Fowler et al on Nov. 9, 1999, and herein incorporated by reference in a manner consistent with the present disclosure.

Other suitable substrates may have encapsulated ingredients such that the capsules rupture during dispensing or use. Examples of encapsulated materials include those disclosed in U.S. Pat Nos. 5,215,757 and 5,599,555 both issued to El-Nokaly and herein incorporated by reference in a manner consistent with the present disclosure. 15 Other suitable substrates include dry substrates that deliver liquid when subjected to in-use shear and compressive forces. Such substrates are disclosed in U.S. Pat No. 6,121,165 entitled Wet-Like Cleaning Articles issued to Mackay et al. Sep. 19, 2000, and herein incorporated by reference in a manner consistent with the present disclosure.

### DETAILED DESCRIPTION

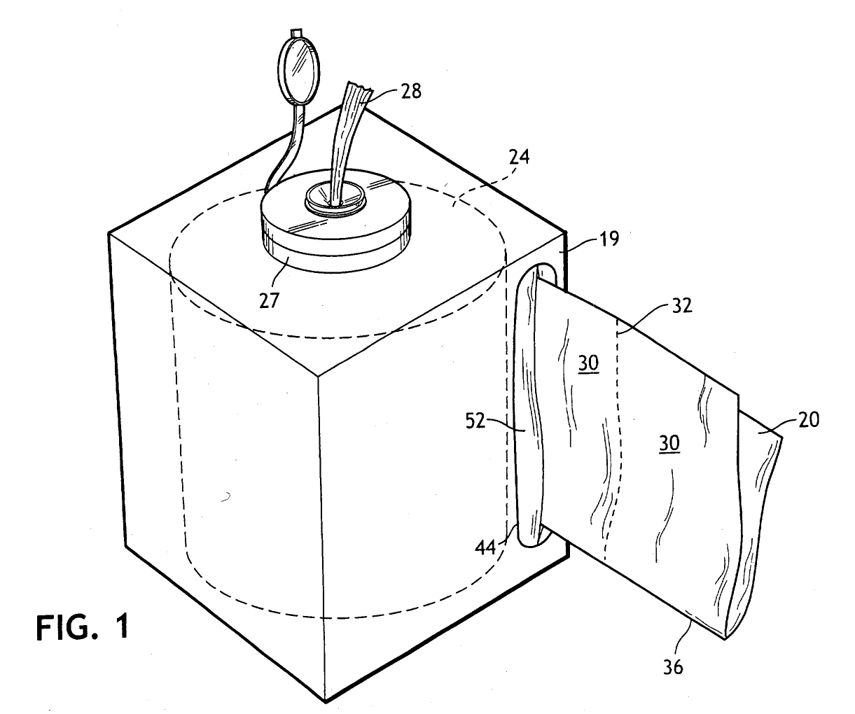

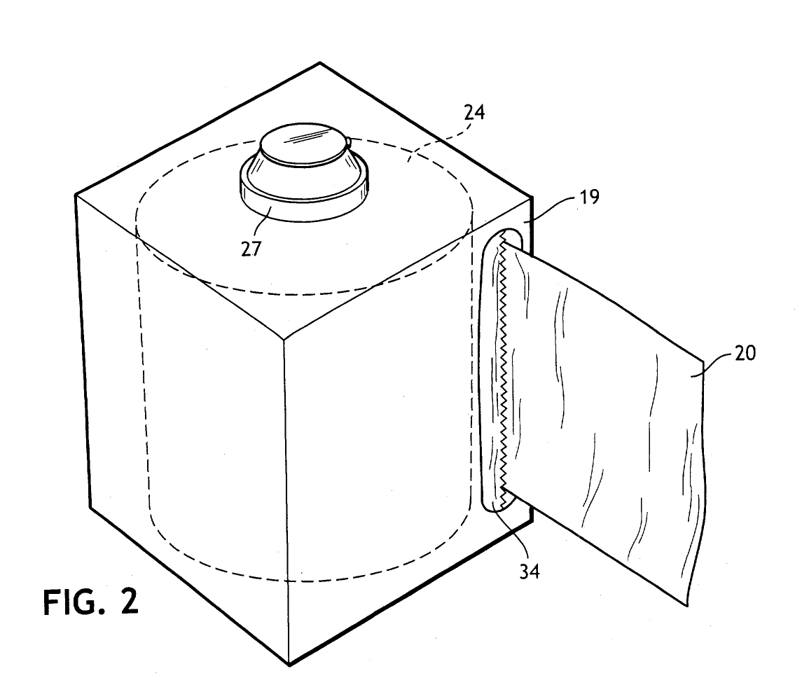

Referring to FIGS. 1-3 various embodiments of the invention are illustrated. An enclosure 19 contains a first substrate 20 that is wound into a roll 24. The roll 24 can be wound about a core 22 or the roll can be wound about a mandrel and removed such that the roll is coreless. The roll 24 has an interior space 26 provided either by the core or by the space previously occupied by the winding mandrel prior to removing the roll 24 from the mandrel. Located within at least a portion of the interior space 26, is a container 27 containing a second substrate 28. The inventive co-packaged product allows for dispensing of the first substrate 20 from the enclosure 19, and dispensing of the second substrate 28 from the container 27. Because the normally wasted interior space 26 is occupied by the container 27, the invention provides for compact packaging of the first and second substrates (20, 28).

Non-limiting embodiments of the present invention include packaging a wet wipe for perineal wiping with a bath tissue roll; packaging a wet wipe for surface cleaning or hand cleaning with a paper towel roll; or packaging a wet wipe for grease removal or hand cleaning with a roll of shop towels. While these particular embodiments have a dry first substrate 20 and a moist second substrate 28, the invention also includes embodiments where each substrate is dry, each substrate is moist, or where the first substrate 20 is moist and the second substrate 28 is dry.

Additionally, the first or second substrate can be formed into other articles prior to being packaged in the enclosure or container. For example, either substrate could be formed into bags or gloves prior to being individually packaged. The gloves could be made from a plastic film and placed into the container and co-packaged with a wet first substrate wound into a roll. Such an application can be useful to automotive body shops in the preparation of surfaces for painting where the wetting solution to clean the surface can be irritating to the hands or skin. The bags could be co-packaged with dry-toilet paper and serve as a commode liner or an emergency toilet.

The roll 24 can be provided with an interior space 26 by winding the first substrate 20 onto the core 22 or by winding the first substrate onto a mandrel to produce a coreless roll. In one embodiment, the roll can contain a plurality of individual sheets 30 separated by a line of perforations 32. The spacing of the perforations can be varied to provide either the same or different sheet lengths within the roll. In another embodiment, the first substrate is continuous and the enclosure 19 provided with a cutter 34 such as a serrated blade or razor blade to sever the first substrate to a desired sheet length. In another embodiment, the roll 24 contained a series of interleaved or overlapped individual sheets wound into a roll. Providing a roll of interleaved individual sheets eliminates the need to either perforate the first substrate or to provide the cutter 34. Suitable interleaved rolls are disclosed in U.S. Pat. No. 5,609,269 entitled Rolled Tissue Products Containing Discrete Overlapped Tissue Sheets issued to Behnke et al. on Mar. 11, 1997, and herein incorporated by reference in a consistent manner. In another embodiment, the first substrate was folded one or more times prior to winding to produce at least one fold line 36. Possible wound folded configurations include a “V” fold, a “C” fold or a “Z” fold. Folding the substrate prior to winding enables a larger sheet to be dispensed from a roll having a shorter height.

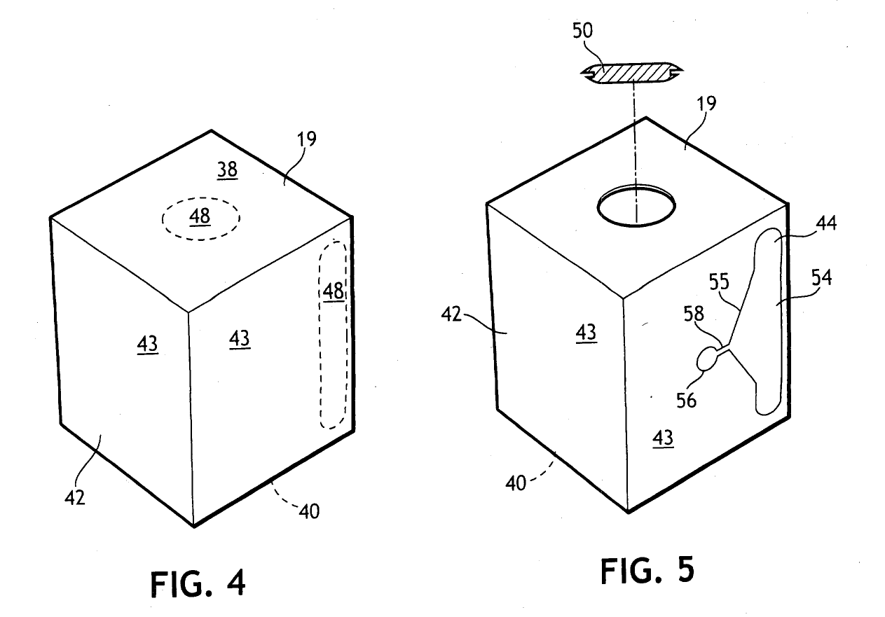

Referring to FIGS. 4, 5, and 6, various embodiments for the enclosure 19 are illustrated. The enclosure 19 housing the roll 24 can provide one or more of the following non-limiting functions: improved dispensing of the first substrate 20, sanity protection of the first substrate 20, shipping and storage of the first substrate 20, shipping and storing of the container 27 within the first substrate, or supporting and restraining of the container 27 when dispensing the second substrate 28.

The enclosure includes a top 38, a bottom 40, and a sidewall 42, and the enclosure can be any suitable size or shape to contain the roll 24. The sidewall 42 can be circular or consist or a plurality of panels 43 to form a hexagonal, octagonal, square, or rectangular shape. The sidewall configuration can be defined by the overall design and intended use for the enclosure or by the size of the roll and desired dispensing attributes. In one embodiment, the enclosure was sized to hold a roll 115 mm high by 125 mm in diameter. In another embodiment, the enclosure was sized to hold a roll 275 mm high by 115 mm in diameter. In anther embodiment, the enclosure was sized to hold a roll 260 mm high by 230 mm in diameter. The size of the roll 24 can vary from the embodiments listed and includes other heights and diameters depending on the desired quantity of the first substrate 20.

The enclosure 19 includes a dispensing opening 44 and at least one container opening 46. In one embodiment, the dispensing opening 44 is located in the sidewall 42, and the container opening 46 is located in the top 38; however, it is possible to reverse the locations or to place either opening in any desired location on the enclosure such as the bottom 40. A container opening 46 located in the bottom 40 may be desired if the enclosure 19 is hung or supported by a wall.

Either the dispensing opening 44 or the container opening 46 or both can be provided with a removable cover 48. Non-limiting examples of removable covers include a removable perforated portion of the enclosure's exterior, a foil or plastic seal, or a film over-wrap. Alternatively, either opening (44, 46) or both can be provided with a removable plug 50 (illustrated in cross-section). Alternatively, either opening (44, 46) or both can be provided with a sliding cover or window for access.

The dispensing opening 44 can be provided with a dispensing member 52 having a slit or aperture 53. Suitable materials for constructing the dispensing member 52 include plastics, films, rubber materials, or paper materials. The dispensing member 52 can function to reduce moisture loss from moist substrates, to prevent the first substrate from falling back or retracting inside of the container, to assist in separating the individual sheets 30, to protect the unused first substrate from contamination, and to assist in dispensing of the first substrate. Alternatively, the dispensing opening 44 can be provided with the previously discussed cutter 34.

The dispensing opening 44 can be configured to any suitable size or shape such as round, oval, rectangular, or the like. In one embodiment illustrated in FIG. 5, the dispensing opening 44 includes a larger first opening 54 having a V-shaped converging region 55 terminating in a slit 58 that is connected to a smaller second opening 56. This dispensing opening is adapted to separate the individual sheets 30 at the line of perforations 32 while also providing ready access to the enclosure's interior for ease in threading the first substrate 20 through the dispensing opening 44. The slit 58 and the second opening 56 provide a restriction through which the first substrate can be guided into by the converging region 55 to separate the individual sheets 30. Additional suitable dispensing openings of this type are disclosed in U.S. Pat. No. 4,436,221 issued to Margulies on Mar. 13, 1984, and herein incorporated by reference in a consistent manner.

The container opening 46 allows for access to the interior space 26 of the roll 24. The container opening is adapted to the size and shape of the container 27 so that at least a portion of the container 27 can be inserted into the interior space 26 through the container opening 46. It can be other geometric shapes in additional to round such as square, triangular, and hexagonal. In one embodiment, a single container opening can be provided. In another embodiment, two container openings located on opposites sides of the enclosure can be provided such that container 27 can be inserted through the core 22 and extend out either side of the enclosure for supporting the enclosure similar to a spindle. The container opening 46 and container 27 can be configured to engage a portion of the container to retain the container within the container opening after insertion.

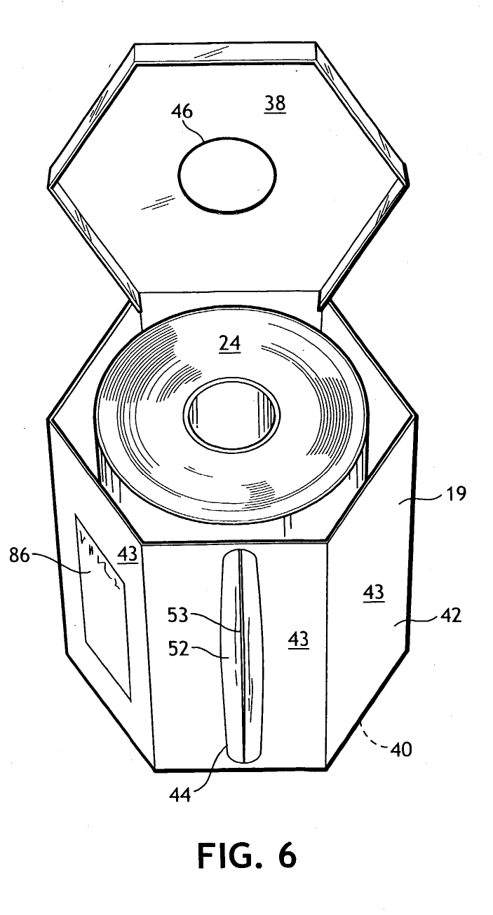

The enclosure 19 can be provided with the panels 43 glued or secured together such that the enclosure is not designed to be refilled after depletion of the first substrate 20. Such enclosures are intended to be thrown away after use. Alternatively, the enclosure 19 can be provided with a hinged or removable portion, such as the top 38, as illustrated in FIG. 6. The removable or hinged portion can be secured in the closed position by means known to those of skill in the art. Such enclosures are refillable and intended for reuse by replacing the depleted first substrate 20 with a new roll 24.

The enclosure 19, in the various embodiments, can be formed of a flexible material like a flexible pouch which permits the container to bend and flex with minimal applied forces. Suitable flexible materials can include films of polyethylene, polyester, polypropylene, polyvinyl chloride, polyamide, acetate, cellophane, or metal foils amongst other suitable alternatives. The film can be single layer, a laminate of the above materials, or a laminate with a metal foil layer. Alternatively, the enclosure 19 can be made of a rigid material. Suitable rigid materials can include paper, board, cardboard, polypropylene, polyethylene, polystyrene, plastic, metal, and glass amongst other suitable alternatives.

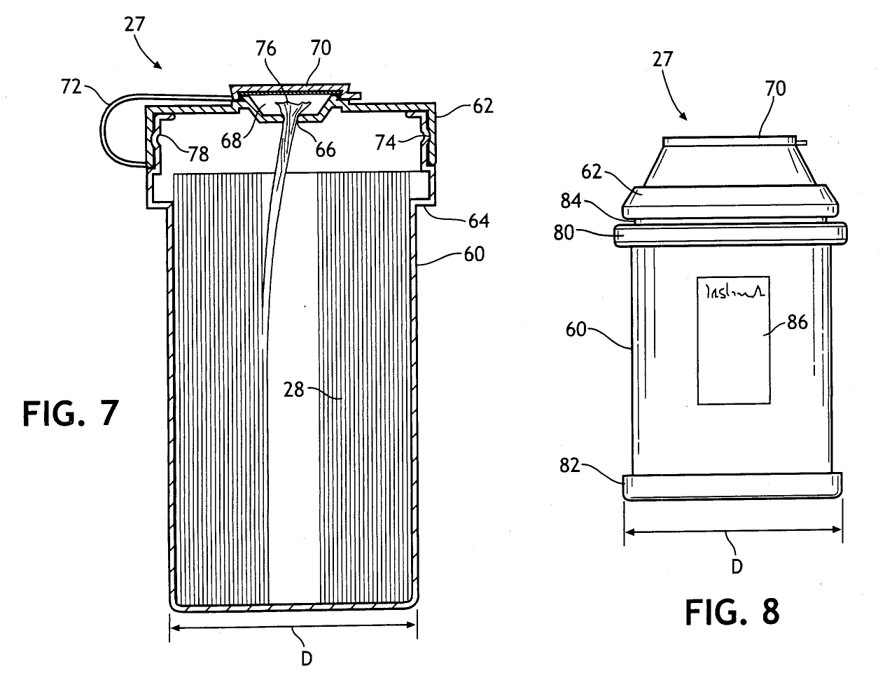

Referring to FIGS. 7 and 8, various embodiments of the container 27 are illustrated. The container 27 can be any suitable size and shape for placement within at least a portion of the interior space 26. The container 27 houses a second substrate 28 located within the container's interior that can be in the form of a roll, a roll with a plurality of individual sheets separated by one or more perforations, a folded stack, an interfolded stack, or other configuration.

Non-limiting examples of suitable containers are disclosed in: U.S. Pat. No. 3,973,695 issued to Ames; U.S. Pat. No. 4,171,047 issued to Doyle et al.; U.S. Pat. No. 4,219,129 issued to Sedwick; U.S. Pat. No. 4,328,907 issued to Beard; U.S. Pat. No. 4,180,160 issued to Ogwa; U.S. Pat. No. 4,534,491 issued to Norton; U.S. Pat. No. 4,651,895 issued to Niske et al.; U.S. Pat. No. 5,467,893 issued to Landis, II et al.; U.S. Pat. No. 6,138,867 issued to Stelmack; U.S. Pat. No. 6,158,614 issued to Haines et al.; and U.S. Pat. No. 6,279,775 issued to Parkes et al. The disclosures of each of the preceding patents are herein incorporated by reference in a consistent manner.

In an embodiment illustrated in FIG. 7, the container 27 includes an open-mouthed cylindrical body 60 having a removable end 62. Alternatively, the body 60 can be another shape such as octagonal or triangular. Enclosed within the container 27 is a second substrate 28 wound into a coreless roll from individual sheets connected by lines of perforations. The cylindrical body includes a shoulder 64 and has a diameter D. The container 27 functions as a spindle when the container is placed through the container opening 46 and inserted into the interior space 26 of the roll 24. Thus, as the first substrate 20 is dispensed, the roll 24 rotates about the cylindrical body 60. The shoulder 64 helps to support the container 27 by resting on the top 38 after insertion, and the shoulder acts as a bearing surface to prevent excessive movement of the container 27 while acting as a spindle.

The diameter D is sized to allow the container 30 to fit inside the core 22 or the interior space 26 of the roll 24, and to allow the roll to rotate about the container 30 as the first substrate 20 is dispensed. In general, the size of D is governed by one or more of the following factors: the desired amount of the second substrate 28 to be placed into the container 27; the desired amount of the first substrate 20 to be provided in the roll 24; the size of the core 22; the diameter of the roll 24; and the relative usage of the first and second substrates (20, 28). In various embodiments, the size D can be less than about 6 inches (15.2 cm), or D can be less than about 4 inches (10.2 cm), or D can be from about 5 inches (12.7 cm) to about 1 inch (2.5 cm), or D can be from about 4.5 inches (11.4 cm) to about 2 inches (5.1 cm), or D can be from about 3.5 inches (8.9 cm) to about 2 inches (5.1 cm).

The removable end 62 can include a dispensing orifice 66, a well 68, a cap 70, a strap 72, and a bead groove 74. The dispensing orifice 66 is configured to provide resistance to the second substrate 28 as it is dispensed to assist in separating the individual sheets at the perforations. Many suitable styles for the dispensing orifice are disclosed in the containers referenced above. The well 68 underneath the cap 70 is sized to provide sufficient space to enclose the exposed tail 76 of the second substrate 28. The cap 70 can be attached to the removable end 62 with the strap 72 to prevent misplacing the cap during use. The bead groove 74 engages an annular bead 78 located on the body 60. The bead groove and annular bead function together to hold the removable end 62 onto the body 60.

In another embodiment illustrated in FIG. 8, the body 60 includes an upper rib 80 and a lower rib 82 such that only a portion of the body's exterior surface contacts the core 22. The diameter D of the raised ribs (80, 82) can have the same ranges as previously 10 discussed. The raised ribs reduce the surface contact between the container 27 and the core 22 reducing rotational drag as the second substrate 28 is dispensed.

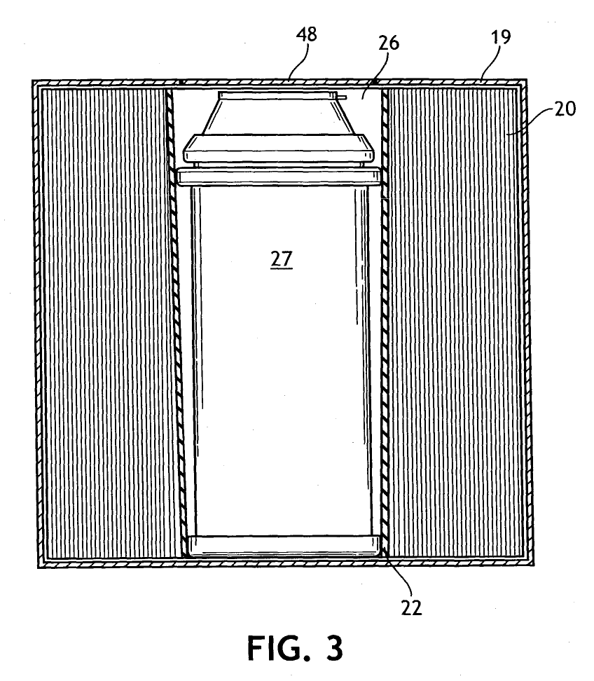

The container 27 of FIG. 8 is designed to be fully enclosed within the core 22 of the roll 24 for shipping and storage prior to use by the consumer as shown in FIG. 3. To facilitate removal of the container 27 from the core, the removable end 62 is tapered. The taper allows for grasping and inserting the container 27 through the container opening 46 after removing the perforated cover 48 from the enclosure 19. In order to retain the container 27 within the enclosure 19, the container has a retaining groove 84 located between the upper rib 80 and the removable end 62. The retaining groove 84 engages the enclosure around the container opening 46. The retaining groove 84 and tapered removable end 62 are sized in combination with the diameter of the container opening 46 to provide a snap fit for securely holding the container in place.

In additional embodiments, the container 27 can comprise a flexible bag material having a resealable cap 70 in the form of a flap with a reusable adhesive for sealing the cap 70 to the container 27 repeatedly. Alternatively, the container 30 can comprise a flexible poly-bag lower portion bonded to a rigid top portion having a hinged cap with a space under the cap to house the exposed tail 76 of the second substrate 28.

The container 27 can be formed of a flexible material which permits the container to bend and flex with minimal applied forces. Suitable flexible materials can include films of polyethylene, polyester, polypropylene, polyvinyl chloride, polyamide, acetate, cellophane, or metal foils amongst other suitable alternatives. The film can be single layer, a laminate of the above materials, or a laminate with a metal foil layer. Alternatively, the container can be made of a rigid material. Suitable rigid materials can include cardboard, polypropylene, polyethylene, polystyrene, plastic, metal, and glass amongst other suitable alternatives.

While the embodiments illustrated in FIGS. 1 to 3 show the enclosure 19 and the container 27 combined together, the invention is not limited to the combination of the two elements. The enclosure 19 and the container 27 are separable into individual components. This allows consumers to replace each substrate as needed and/or to use the substrates individually as packaged if desired. For instance, if the second substrate 28 is depleted prior to using up all of the first substrate 20, the container 27 can be removed and a new container 27 inserted into position. In order to communicate this functionality to the consumer, the enclosure 19 and/or the container 27 can be provided instructions 86 on their exteriors. The instructions 86 can be either written directions, graphic/pictorial directions, or a combination of both. For instance, the instructions 86 can be located on any portion of the enclosure 19 such as panel 43, and communicate either through words or pictures or both to remove the cover 48, if provided, and to insert the container 27 into the container opening 46. Alternatively, if the container 27 resides within the core 22 as illustrated in FIG. 3, the instructions 86 can direct the consumer to remove the cover 48, and pull the container through the container opening 46 until the retaining groove 84 engages with the top 38. Similarly, the container 27 can be provided with the instructions 86. The instructions can direct the consumer to insert the container into the container opening 46 of the enclosure 19 such that at least a portion of the container resides within the interior space 26.

The enclosure 19 and the roll of the first substrate 20 can be sold separately or packaged in multi-packs containing two, three, or more enclosures. Each enclosure 19 can be provided with the instructions 86 to direct consumers that the container 27 can be placed into the enclosure through the container opening 46. Alternatively, the packaging surrounding the enclosures 19 can have the instructions or an instruction sheet 88 can be packaged with the enclosures.

Similarly, the container 27 and the second substrate 28 can be sold separately or packaged in multi-packs containing two, three, or more containers. The container 27 can be provided with instructions to direct consumers to place the container 27 into the enclosure 19 through the container opening 46. Each container 27 can be provided with the instructions 86 to direct the consumers to place the container 27 into the enclosure 19 through the container opening 46. Alternatively, the packaging surrounding the containers 27 can have the instructions or an instruction sheet 88 can be packaged with the enclosures.

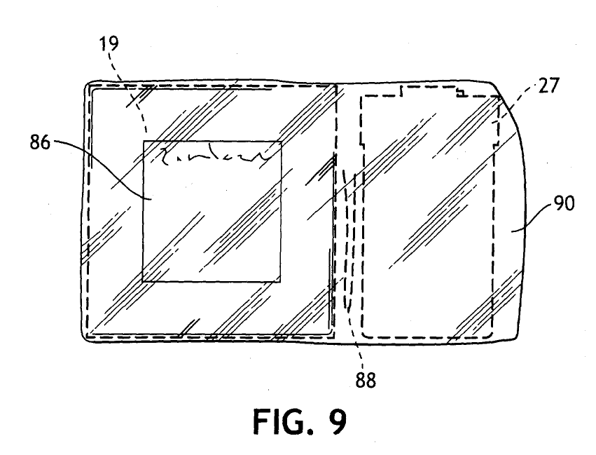

Alternatively as illustrated in FIG. 9, the enclosure 19 and the container 27 can be packaged together, but without the container inserted into the enclosure. The instructions 86 can be placed onto the instruction sheet 88 packaged with the enclosure and the container or the instructions 86 can be placed on the packaging 90 surrounding the enclosure and the container.

It will be appreciated that the foregoing description, given for the purposes of illustration, is not to be construed as limiting the scope of the invention, which is defined by the claims and all equivalents thereto.

We claim:

1. A combination comprising:
a first substrate wound into a roll having an interior space, and the roll housed within an enclosure;
a second substrate located within a container; and at least a portion of the container placed into the interior space.

2. The combination of claim 1 wherein the first substrate comprises a dry substrate and the second substrate comprises a moistened substrate.

3. The combination of claim 2 wherein the first substrate comprises cellulose fibers.

4. The combination of claim 2 wherein the second substrate comprises a wet wipe.

5. The combination of claim 1 wherein the first substrate comprises a moistened substrate and the second substrate comprises a dry substrate.

6. The combination of claim 5 wherein the first substrate comprises a wet wipe.

7. The combination of claim 5 wherein the second substrate comprises cellulose fibers.

8. The combination of claim 1 wherein the second substrate is wound into a roll.

9. The combination of claim 1 wherein the second substrate is interfolded.

10. The combination of claim 1 wherein the roll is wound on a core.

11. A combination comprising:
a first substrate wound into a roll about a core having an interior space, and the roll housed within an enclosure;
the enclosure comprising a top, a bottom, a sidewall, a container opening, and a dispensing opening;
a container comprising a cylindrical body having a diameter D, the container housing a second substrate; and
the container placed within the container opening of the enclosure such that at least a portion of the container resides within the interior space of the core.

12. The combination of claim 11 wherein the dispensing opening comprises a cutter for cutting the first substrate.

13. The combination of claim 11 wherein the dispensing opening comprises a dispensing member having an aperture for dispensing the first substrate.

14. The combination of claim 11 wherein the dispensing opening comprises a first opening having a converging region connected by a slit to a second opening.

15. The combination of claim 14 wherein the second opening is smaller than the first opening.

16. The combination of claim 11 wherein the container opening or the dispensing opening or both are covered by a cover.

17. The combination of claim 16 wherein the cover comprises a removable perforated portion of the enclosure.

18. The combination of claim 16 wherein the cover comprises a plug.

19. The combination of claim 11 wherein the container opening is located in the top and the dispensing opening is located in the sidewall.

20. The combination of claim 11 wherein the container comprises a shoulder for supporting the container when placed into the container opening.

21. The combination of claim 11 wherein the container comprises a retaining groove for securing the container within the container opening.

22. The combination of claim 11 wherein the cylindrical body comprises an upper rib and a lower rib.

23. The combination of claim 11 wherein the diameter D is less than about 6 inches.

24. The combination of claim 11 wherein the container comprises a removable end attached to the cylindrical body and the removable end is tapered.

25. The combination of claim 11 wherein the entire container is enclosed by the core until removed and placed within the container opening.

26. The combination of claim 11 wherein the first substrate comprises cellulose and the second substrate comprises a wet wipe.

27. A product comprising:
an enclosure having a container opening housing a roll of a first substrate; and
instructions directing the placement of a container housing a second substrate into the container opening.

28. The product of claim 27 wherein the instructions comprise written directions.

29. The product of claim 27 wherein the instructions comprise pictorial directions.

30. A product comprising:
a container housing a second substrate; and
instructions directing the placement of the container into a container opening in an enclosure housing a roll of a first substrate.

31. The product of claim 30 wherein the instructions comprise written directions.

32. The product of claim 30 wherein the instructions comprise pictorial directions.

33. A kit comprising:
an enclosure having a container opening housing a roll of a first substrate, and the roll having an interior space;
a container housing a second substrate; and
instructions for placing the container into the container opening such that at least a portion of the container resides within the interior space of the roll.

34. The kit of claim 33 wherein the instruction comprise an instruction sheet.

35. The kit of claim 33 wherein the enclosure and the container are placed within packaging material.

36. The kit of claim 35 wherein the instructions are placed on the packaging material.
